(19) United States
(12) Patent Application Publication
(10) Pub. No.: US 2014/0214534 A1
(43) Pub. Date: Jul. 31, 2014

(54) RESTAURANT MENU GENERATION AND IN-RESTAURANT PROMOTIONS

(71) Applicants: ISRAEL L'HEUREUX, MONACO (MC); MARK D. ALLEMAN, PORTLAND, OR (US)

(72) Inventors: ISRAEL L'HEUREUX, MONACO (MC); MARK D. ALLEMAN, PORTLAND, OR (US)

(21) Appl. No.: 13/654,804

(22) Filed: Oct. 18, 2012

(51) Int. Cl. G06Q 30/02

(52) U.S. Cl. 705/14.53; 705/14.64

(57) ABSTRACT

Restaurant menu generation and in-restaurant promotions are provided in the context of a computer implemented electronic restaurant menu. As one example, in-restaurant promotions are displayed on a mobile device by detecting the existence of a dining event currently underway in a restaurant via the mobile device. The dining event indicates presence of the mobile device in the restaurant, and further indicates a stage of a dining experience. An electronic restaurant menu is displayed at a graphical display of the mobile device. A promotion is identified based on the stage of the dining experience and the presence of the mobile device in the restaurant. The promotion may be associated with a menu item on the electronic restaurant menu. The promotion is displayed at the graphical display of the mobile device.

### CROSS-REFERENCE TO RELATED APPLICATION

The present application is related to U.S. patent application Ser. No. 13/242,437, titled LOCATION SENSITIVE PROCESSING OF RESTAURANT ORDERS, and is also related to U.S. patent application Ser. No. 13/481,807, titled PROCESSING RESTAURANT ORDERS WITHIN COMPUTING SYSTEMS, the entire contents of these documents are incorporated herein by reference in their entirety for all purposes.

### BACKGROUND

Restaurants typically serve customers by presenting a hardcopy printed version of a restaurant menu to the customers, taking orders from the customers, preparing the menu items ordered by the customers, and delivering the menu items to the customers. Some restaurants take orders for multiple stages of the dining experience as a single combined order submission, while other restaurants take orders for multiple stages of the dining experience as separate orders that are periodically elicited by restaurant staff and submitted by the customers over the course of the dining experience. Many restaurants offer daily specials or promotions that are verbally communicated by the restaurant staff, often at the time of delivery of the restaurant menu to the customers or prior to customers' placement of the orders. Restaurant staff are often responsible for a large number and range of tasks, a large number of frequently changing customers, and a large number of frequently changing menu items, specials, or promotions.

### SUMMARY

Restaurant menu generation and in-restaurant promotions are provided in the context of a computer implemented electronic restaurant menu. As one example, in-restaurant promotions are displayed on a mobile device by detecting the existence of a dining event currently underway in a restaurant via the mobile device. The dining event indicates presence of the mobile device in the restaurant, and further indicates a stage of a dining experience. An electronic restaurant menu is displayed at a graphical display of the mobile device. A promotion is identified based on the stage of the dining experience and the presence of the mobile device in the restaurant. The promotion may be associated with a menu item on the electronic restaurant menu. The promotion is displayed at the graphical display of the mobile device.

This Summary presents only a small selection of the various concepts described in further detail by the Detailed Description and associated drawings, and is not intended to be used to limit the scope of the claimed subject matter.

### BRIEF DESCRIPTION OF DRAWINGS

FIG. 1 is a schematic diagram depicting an example restaurant menu generation and in-restaurant promotion delivery system.

FIG. 2 is a schematic diagram depicting an example graphical user interface.

FIG. 3 is a flow diagram depicting an example method for displaying in-restaurant promotions on a mobile device.

FIG. 4 is a flow diagram depicting an example method for restaurant menu generation including an in-restaurant promotion.

FIG. 5 is a schematic diagram depicting an example computing system.

### DETAILED DESCRIPTION

A restaurant menu is generated and displayed to customers physically present at a restaurant. The restaurant menu may take the form of a customized or customizable electronic restaurant menu that is presented to customers via a computing device, such as a mobile device carried by a customer. The content and/or format of the restaurant menu may be varied on an individual customer basis and may be varied among stages of a customer's dining experience.

In-restaurant promotions may be targeted to customers physically present at a restaurant upon satisfaction of associated display criteria. Display criteria may be evaluated on an individual customer basis for individual stages of the customer's dining experience to further improve the relevancy of the promotions. Promotions may be displayed to customers via a computing device within the context of a restaurant menu.

As an illustrative example, a customer may carry his or her mobile device to a restaurant. A restaurant menu may be presented to the customer via a graphical display of the mobile device upon detection of the mobile device at the restaurant. The restaurant menu may be customized for the current stage of the dining experience. For example, the restaurant menu may be customized to include dessert items during a dessert stage of the dining experience. The restaurant menu may be further customized for that customer based on the customer's profile information. The customer's profile information may include biographical information for the customer, the customer's past order history, customer preferences, or other suitable information.

A promotion forming part of the restaurant menu may be presented to the customer upon satisfaction of display criteria associated with that promotion. Advertisers may register promotions by associating display criteria with the promotion content. Display criteria may include (1) the restaurant identity, name, or type, (2) the stage of the dining event, (3) menu items present on the restaurant menu, and (4) customer profile information, among other suitable criteria. The customizable nature of electronic restaurant menus enable advertisers to better promote their products in a programmatically targeted manner, thereby reducing or eliminating reliance on restaurant staff to identify relevant promotions, or recommend and present the relevant promotions to the customers. For example, a promotion may be presented to a customer upon that customer arriving at a restaurant, the customer ordering two gin and tonic beverages that includes brand “X” gin, and the customer reaching the dessert stage of the dining experience. The customer, for example, may be offered a promotion during the dessert stage for something sweeter than the previous gin and tonic beverages, such as a Negroni of the same brand “X” gin, based on a registered promotion of the brand “X” gin company.

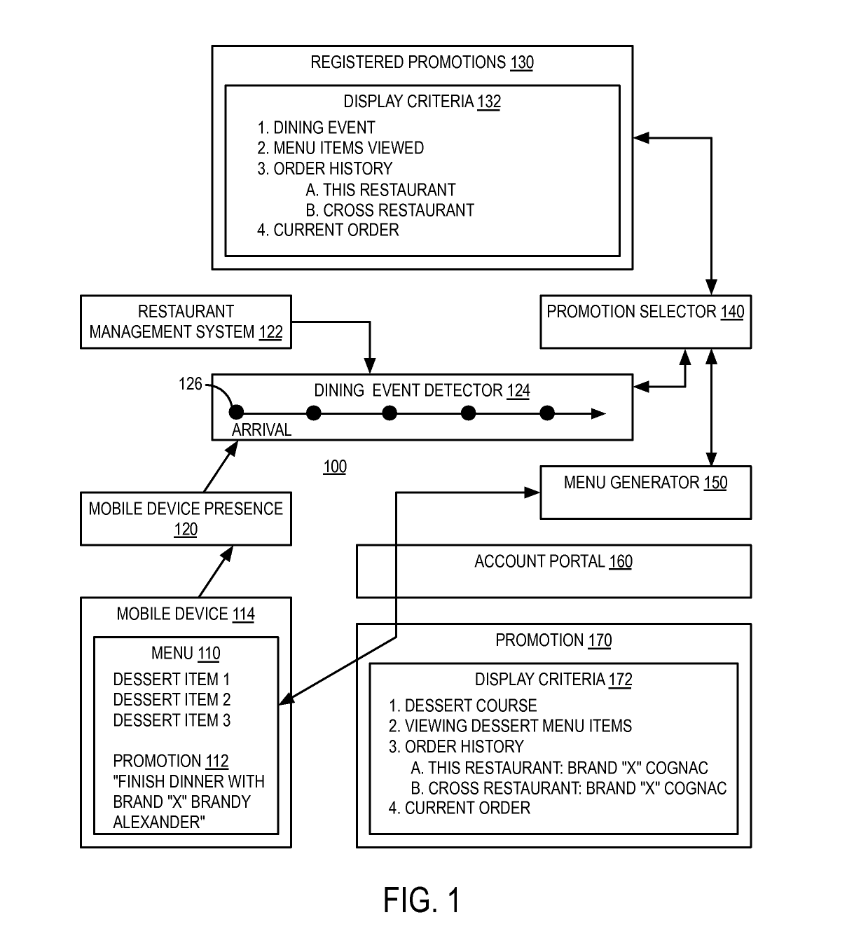

FIG. 1 is a schematic diagram depicting an example restaurant menu generation and in-restaurant promotion delivery system 100. Within system 100, a mobile device 114 carried by a customer may display a menu 110 that includes menu items and a promotion 112. The presence of mobile device 114 at a restaurant is identified at 120. Dining event detector 124 may receive an indication of the presence of mobile device 114 at the restaurant. A customer as a user of mobile device 114 may optionally log-in via an account portal 160 to enable functional entities of system 100 to distinguish the customer from other customers and/or to indicate the customer's presence at the restaurant. However, log-in processes may be automated on-behalf of the customer based on detection of a mobile device identifier, for example. Restaurant management system 122 may provide dining event detector 124 with a set of dining stages, such as arrival 126, an appetizer course, a main course, a dessert course, etc.

Promotions may registered by advertisers as registered promotions 130. A variety of display criteria may be associated with the registered promotions for use in determining eligibility of the registered promotions on a menu at a given restaurant. Registered promotions may be matched to actual dining events at menu-view time during the dining experience, to present the user with contextually relevant promotions based on one or more of: (1) the user's mobile device presence within the restaurant, (2) detected dining event stage, (3) menu items being currently viewed on the mobile device, (4) the user's order history during the current dining experience, (5) the user's past order history at the current restaurant and/or other restaurants, or other suitable user profile information.

Promotion selector 140 receives an indication of a current dining event and/or dining stage of the dining event from dining event detector 124, identifies display criteria 132 of registered promotions 130, and selects a promotion (e.g., promotion 170) for delivery to the mobile device, such as alongside or part of menu 110. Display criteria associated with each registered promotion may be used to drive promotion selection. For example, within FIG. 1, menu 110 is currently presenting a dessert menu for a dessert stage of a dining event. Promotion 170 that was selected by promotion selector 140 is associated with display criteria 172 that indicates that the promotion is applicable, for example, to: (1) a dessert course within the dining event, (2) when the user is viewing the dessert menu items, (3) when the user's order history includes Brand “X” Cognac in this restaurant or other restaurants.

Menu generator 150 generates a relevant menu for the current dining stage indicated by dining event detector 124, and further receives a selected promotion from promotion selector 140. Menu generator supplies the relevant menu (e.g., menu 110) to mobile device 114 for presentation to the user along with the selected promotion (e.g., promotion 112). It will be understood that menu 110 may present different menu items depending on the stage of the dining experience, and may present different promotions depending on the user, the stage of the dining experience, and other suitable display criteria. Hence, advertisers may define display criteria to direct targeted promotions to users at relevant stages of the dining experience.

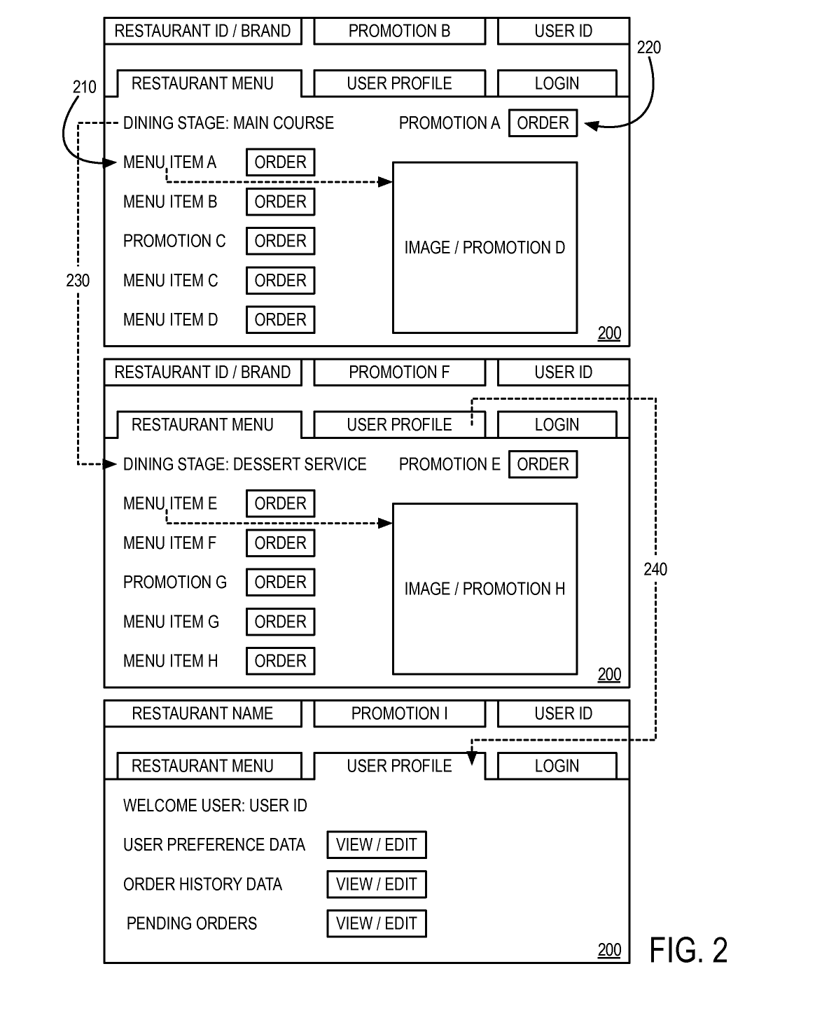

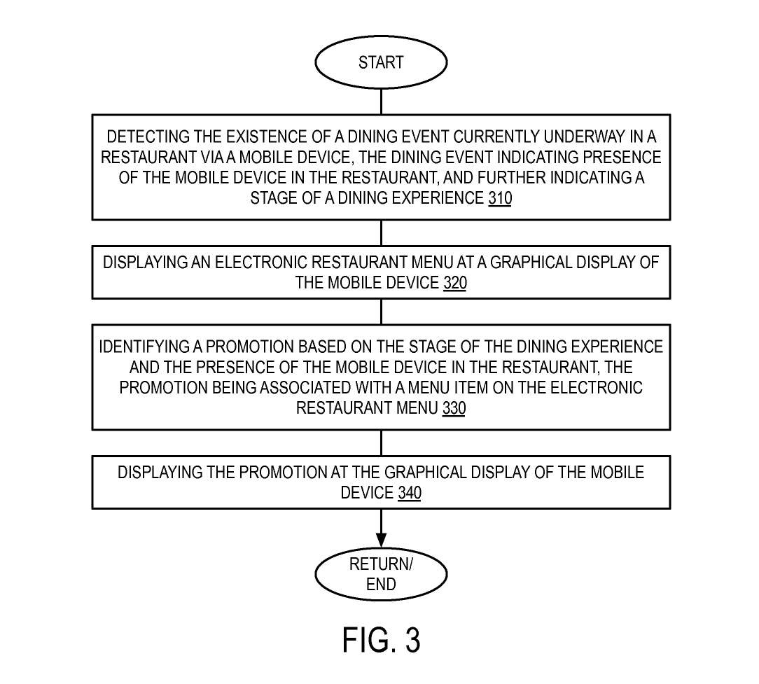

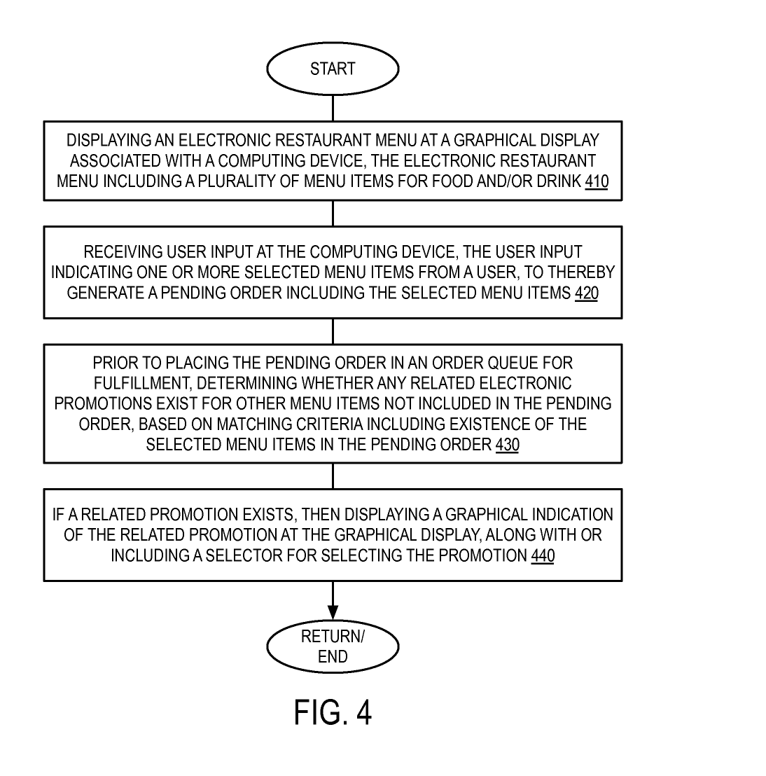

FIG. 2 is a schematic diagram depicting an example graphical user interface (GUI) 200 that includes an electronic restaurant menu 210. GUI 200 may be displayed at a graphical display of a computing device, such as a mobile device or on-premises computing device, for example. Restaurant menu 210 may include one or more menu items of food and/or drink. GUI 200 may further include one or more promotions 220. As will be described in greater detail with reference to FIGS. 3 and 4, promotions may be identified and displayed based on and responsive to a stage of a dining experience underway in a restaurant and/or responsive to a user profile as defined by display criteria associated with the promotions.

It will be understood that the term “restaurant” as used herein is meant to encompass establishments that serve food and/or drinks to customers, and thus includes not only traditional sit-down restaurants, but also take out venues, delicatessens, bars, food carts, and other such establishments offering food and/drinks. Accordingly, the dining events discussed herein will be understood to encompass events relating to the customer arrival, seating, ordering, consuming of food and/or drinks, follow-on orders and consumption, and eventual departure from such establishments.

A first instance of GUI 200 is depicted for display during or prior to a main course stage of the dining experience. This first instance of GUI 200 includes menu items A, B, C, and D; and promotions A, B, C, and D. Promotion A may indicate, for example, 50% off of a particular entree. Menu items and promotions may include or may be associated with a selector that enables a user to order the menu item or promotion. Within the first instance of GUI 200, promotions A and B are visually set apart from other menu items of electronic restaurant menu 210; promotion C takes the form of an inline advertisement in electronic restaurant menu 210; and promotion D takes the form of an image associated with a menu item (e.g., Menu Item A) in electronic restaurant menu 210.

As the current stage of the dining experience progresses to a subsequent stage, as indicated at 230, a second instance of GUI 200 may be displayed at the computing device. For example, the second instance of GUI 200 may be displayed before or during a dessert service stage of the dining experience. This second instance of GUI 200 includes menu items E, F, G, and H; and promotions E, F, G, and H. Promotion E may indicate, for example, buy one get one free of a particular dessert item. However, it will be understood that any suitable promotions may be used.

GUI 200 may include additional features, such as a login feature that enables a user to submit user credentials (e.g., a user name and/or password) for accessing a corresponding user account. A user identifier may be presented at GUI 200 for that user upon successful logon to the user account. GUI 200 may further include a restaurant identifier and/or branding for the restaurant with which the order is to be placed. GUI 200 may be updated to reflect different restaurants, enabling a user to place orders with multiple independent restaurants via a common mobile device and application program, for example.

GUI 200 may further include a user profile feature that may be accessed by a user as indicated, for example, as a third instance of GUI 200. The third instance of GUI 200 corresponding to a particular user profile may include user preference data, order history data, and/or pending order information for a particular user. Preference data, order history data, and/or pending order information may each be associated with a selector that enables a user to view and/or edit the respective information. As one example, a user may edit the preference data to view and edit the type of promotions or menu items presented to the user. As another example, a user may view and edit pending orders previously placed by the user, but not yet fulfilled by the restaurant staff.

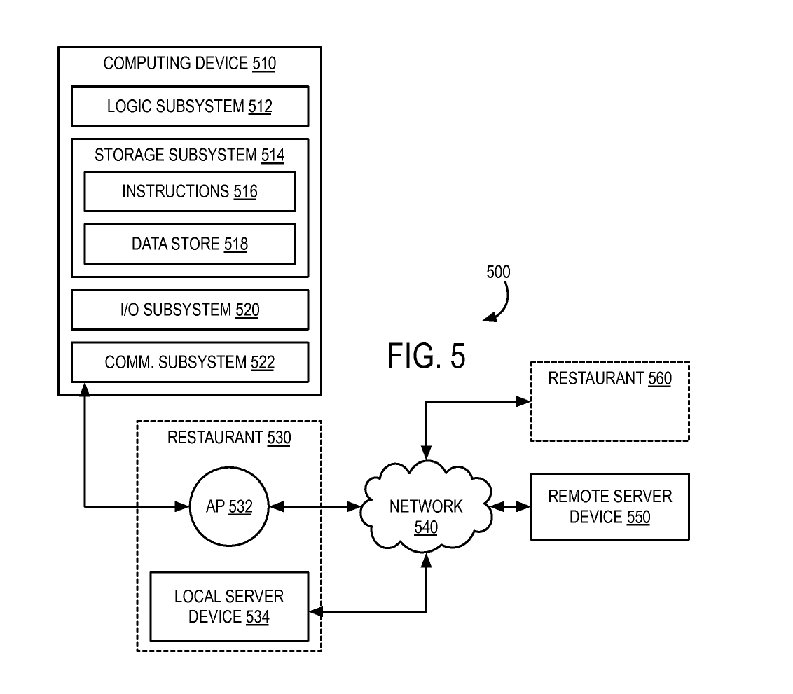

FIG. 3 is a flow diagram depicting an example method 300 for displaying in-restaurant promotions on a mobile device. Method 300 may take the form of a computerized method in which one or more computing devices perform method 300 or portions thereof by executing instructions at a logic subsystem of the one or more computing devices. A computing system including one or more example computing devices is described in greater detail with reference to FIG. 5.

At 310, the method includes detecting the existence of a dining event currently underway in a restaurant via a mobile device. The existence of the dining event may indicate or may be indicated by the presence of the mobile device in the restaurant or on restaurant premises. The presence of the mobile device in the restaurant or on restaurant premises may be detected from communications between the mobile device and a wireless access point located on or near the restaurant premises and/or from geo-location information obtained by the mobile device from navigation satellites and/or wireless base stations. Geo-location information for the mobile device may be compared to geo-location information for the restaurant to detect mobile device presence at the restaurant.

The existence of the dining event may further indicate a stage of the dining experience, such as a multi-stage dining experience. Example stages of a dining experience may include one or more of: restaurant arrival, seating, menu service, drink service, appetizer and main course service, dessert service, payment, restaurant departure, first round of drinks, second round of drinks, third round of drinks, etc., among other suitable stages. As one example, the stage of the dining experience may be selected from a group consisting of: restaurant arrival, seating, menu service, drink service, appetizer and main course service, dessert service, payment, restaurant departure. As another example, the stage of dining experience may be selected from a group consisting of: first round of drinks, second round of drinks, third round of drinks. It will be understood that other suitable stages of the dining experience or combinations of stages may be selected depending on implementation, restaurant manager discretion, and/or restaurant theme. In some implementations, the user may provide a user input to the mobile device to select the current stage of the dining experience. In other implementations, the stage of the dining experience may be updated by mobile device software and/or server software responsive to orders placed by the user without requiring the user to identify or otherwise define the current stage. For example, a multi-stage dining experience may include two or more stages having a predefined sequence relative to each other.

At 320, the method includes displaying an electronic restaurant menu at a graphical display of the mobile device. A non-limiting example of an electronic restaurant menu is previously described restaurant menu 210 of GUI 200 of FIG. 2. However, it will be understood that other suitable electronic restaurant menus may be displayed or otherwise presented via the mobile device.

At 330, the method includes identifying a promotion based on the stage of the dining experience and the presence of the mobile device in the restaurant. The identified promotion may be associated with a menu item on the electronic restaurant menu. For example, a particular brand of beverage may be associated with a promotion for 50% off the price of that brand of beverage. The promotion may be identified based upon the associated menu item that is currently displayed in the restaurant menu. Identifying the promotion at 330 may be further based on other items in a pending order placed via the mobile device, including promotions associated with or linked to those pending orders. For example, if a user has placed an order for a breakfast entre, then the promotion may include another breakfast item that is associated with the ordered breakfast entre.

In at least some implementations, thresholding may be applied to a particular promotion or group of promotions to limit the presentation of promotions responsive to satisfaction of a threshold condition. As one example, promotions for alcoholic beverages of a particular type or alcoholic beverages in general may be reduced, limited, or discontinued if a threshold number of alcoholic beverages have been ordered by the customer or by a table at which the customer is seated. As another example, a threshold condition may limit a quantity of promotions for a particular class or brand of items presented within a period of time. Thresholding of promotions may be relaxed to once again enable the presentation of previously limited promotions upon the customer or the table at which the customer is seated placing an order for a different class or brand of items, such as non-alcoholic beverages or food items, for example.

As a non-limiting example, a customer may place an order for a gin and tonic beverage via the customer's mobile device. Upon confirmation of that order, a promotion may be presented to the customer for brand “X” gin as an ingredient for the gin and tonic beverage. If the customer subsequently places another order for a gin and tonic beverage, then a promotion presented to the customer may be changed to brand “Y” gin as an ingredient for the gin and tonic beverage, or the promotion may include a different type of alcoholic beverage (e.g., a beer) or a different class of items (e.g., a food item).

At 340, the method includes displaying the promotion at the graphical display of the mobile device. The promotion may take the form of text, an image, and/or a selector that enables a user to order an item or product associated with the promotion. For example, in the context of GUI 200 of FIG. 2, a user may select an ORDER selector to add the promotion to a pending order queue to be processed by the restaurant.

The promotion displayed at the graphical display of the mobile device may be varied responsive to the stage of the dining experience changing over time. For example, as previously discussed with reference to GUI 200 of FIG. 2, the promotions and/or menu items that are displayed via the mobile device may be updated to reflect the current or upcoming stage of the dining experience.

User order preferences may be tracked based on in-restaurant orders made from the mobile device. The promotion may be identified at 330 further based on the user order preferences. User order preferences may be tracked in or across a plurality of different restaurants. At least some of these different restaurants may be owned or operated by different entities. User order preferences may be unified across different restaurants by each restaurant registering with a network service that aggregates, stores, and reports user order preferences across a broad network of restaurants.

Tracking user order preferences may be accomplished, at least in part, by: for each restaurant of a plurality of restaurants, (1) determining presence of the mobile device of a user in the respective restaurant; (2) downloading restaurant data including a menu having at least one menu option for the respective restaurant to the mobile device; (3) receiving user order input for at least one menu selection from the menu options of the menu, via the mobile device; (4) receive confirmation of the user order input, via the mobile device; (5) send a message from the mobile device to a remote server with the user order preferences based on the at least one menu selection in the order; and (6) at the server, augment the user profile based on the user order preferences.

The user order preferences may include an order history and/or weighted category preferences for different categories of food and/or drink. Menus for each restaurant may include metadata assigning categories and values to each menu item, for use in generating the weighted category preferences for each menu selection.

In at least some implementations, the promotion may take the form of a pull promotion inserted into the electronic restaurant menu. As one example, the pull promotion may be displayed as an inline advertisement in the electronic restaurant menu. As another example, the pull promotion may take the form of a sponsored menu item visually set apart from other menu items in the electronic restaurant menu. The pull promotion may be displayed as text and/or an image associated with a menu item in the electronic restaurant menu. Further, the pull promotion may be displayed in a higher rank in the electronic restaurant menu as compared to other menu items and/or in an exaggerated size, color, typeface, or highlighting, as compared to the other menu items, and/or the promotion may be presented with visual icons to further emphasize the promotion relative to other menu items.

FIG. 4 is a flow diagram depicting an example method 400 for restaurant menu generation including an in-restaurant promotion. Method 400 may take the form of a computerized method in which one or more computing devices perform method 400 or portions thereof by executing instructions at a logic subsystem of the one or more computing devices. A computing system including one or more example computing devices is described in greater detail with reference to FIG. 5.

At 410, the method includes displaying an electronic restaurant menu at a graphical display associated with a computing device. The electronic restaurant menu may include a plurality of menu items for food and/or drink. A non-limiting example of an electronic restaurant menu is previously described restaurant menu 210 of GUI 200 of FIG. 2. However, it will be understood that other suitable electronic restaurant menus may be displayed or otherwise presented.

At 420, the method includes receiving user input at the computing device. The user input may indicate one or more selected menu items from a user, to thereby generate a pending order including the selected menu items.

As previously described, thresholding promotions may be applied to reduce, limit, or preclude selection and presentation of certain promotions upon satisfaction of a threshold condition. Thresholding may also be applied to the ordering of food or beverage items. For example, ordering of alcoholic beverages may be limited to less than a threshold quantity per period of time or dining experience. Such thresholding may be overridden if, for example, the customer indicates that the alcoholic beverage was ordered for another customer seated at the table or a customer recently joining the table.

At 430, prior to placing the pending order in an order queue for fulfillment by restaurant staff, the method includes determining whether any related electronic promotions exist for other menu items not included in the pending order, based on matching criteria including existence of the selected menu items in the pending order. As one example, a determination may be made as to whether any related electronic promotions exist by: (1) querying a local or remote promotions database server for promotions that match the matching criteria; and (2) receiving a response from the database server with a matching promotion. The electronic restaurant menu may be preformatted to include space in which the matching promotion may be displayed adjacent the pending order.

At 440, if a related promotion exists, then the method includes displaying a graphical indication of the related promotion at the graphical display, along with or including a selector for selecting the promotion. It will be understood that the displaying function performed at 440 may include an application program of a computing device initiating display of graphical information by sending information to an operating system of the computing device, whereby the operating system causes the graphical information to be displayed.

The method may further include receiving user input selecting the promotion at the mobile device. In response to receiving the user input, the method may further include one or more of: selecting the promotion, changing the pending order to add a promotion menu item, and/or deleting an existing selected menu item from the pending order.

The method may further include determining a user identifier associated with the user. A user profile database may be queried to retrieve a user profile associated with the user. The user profile may contain preference data and/or order history data. The matching criteria applied at 430 may further include the preference data and/or the order history data in the user profile such that related promotions are matched to the user profile data during the determination whether any related electronic promotions exist for other menu items not included in the pending order. As previously described with reference to method 300 of FIG. 3, user profile information may include preference data and/or order history data that has been aggregated from a plurality of different restaurants. The user profile information may be stored, updated, and/or retrieved from a network server device by a user's computing device as the user travels between or among different restaurants over the course of multiple dining experiences.

FIG. 5 is a schematic diagram depicting an example computing system 500. Computing system 500 includes a number of computing devices, including computing device 510, a local server device 534, and a remote server device 550.

Computing device 510 is depicted in further detail than server devices 534 and 550. However, it will be understood that server device 534 and 550 may include similar features as computing device 510. As one example, computing device 510 may take the form of a user's personal computing device. As another example, computing device 510 may take the form of a restaurant owned computing device that the user, as a customer of the restaurant, may use to place an order. Computing device 510 may include a mobile device such as a handheld computer, handheld programmable communications device, or other suitable portable electronic device. In other examples, computing device 510 may take the form of a personal computer, multimedia entertainment system, point-of-sale system, or other suitable electronic device.

Computing device 510 may include one or more of: a logic subsystem 512, a storage subsystem 514, an input/output subsystem 520, and a communication subsystem 522, among other suitable components. Logic subsystem 512 may include one or more processors, logic machines, and/or other suitable electronic circuitry for implementing the functionality described herein. Storage subsystem 514 may include or otherwise have instructions 516 and/or a data store 518 stored thereon. Instructions 516 may be executable by logic subsystem 512 to perform or otherwise provide the methods, processes, or functions described herein. As one example, instructions 516 may include an application program that presents a graphical user interface to the user at a graphical display through which the user may interact with the computing device. Data store 518 may include any suitable information, including the databases and/or data structures described herein. Non-limiting examples of information contained within data store 518 include the previously described user profile information, menu items, promotions, and/or matching criteria. Input/output subsystem 520 may include or may be configured to communicate with one or more input and/or output devices, and may include one or more of: a graphical display, a keyboard, a keypad, a pointing device such as a computer mouse, a touch-sensitive graphical display, an audio speaker, an audio microphone, a haptic feedback device (e.g., vibration element), etc. Communication subsystem 522 may support wired and/or wireless communication with other computing devices or network elements via any suitable communication protocol. Accordingly, communication subsystem 522 may include one or more transmitters, receivers, transceivers, amplifiers, filters, processors, etc.

Restaurant 530 may own or operate one or more on-premises wireless access points, such as example wireless access point 532 with which computing device 510 may communicate with a broader communications network 540. As one example, access point 532 may take the form of a Wi-Fi access point. However, other suitable communication protocols may be supported. Communications network 540 may include a wide area network (e.g., the Internet) supporting communication with remote server device 550 and/or a local area network (e.g., an Intranet) supporting communication with an on premises local server device 534. As previously discussed, local server device 534 and/or remote server device 550 may each include a data store and/or instructions that are executable by their respective logic subsystems to perform or otherwise provide the methods, processes, or functions described herein. Such instructions may be paired with or otherwise configured to communicate with instructions 516 (e.g., an application program) of computing device 510. Remote server device 550 may support communications with multiple independent restaurants and associated on-premises equipment and/or customer equipment, thereby enabling aggregation of user profile information across multiple independent restaurants.

One or more of computing device 510, local server device 534, and/or remote server device 550 may be configured to determine a location of computing device 510 using a variety of different geo-locating techniques or a combination of such techniques. Non-limiting examples of geo-locating techniques include use of satellite and/or base station triangulation and/or proximity sensing, and/or user initiated “check-in” by which the user provides a user input indicating the user's presence at a particular location (e.g., restaurant). Computing device 510, local server device 534, and/or remote server device 550 may be configured to associate the location of computing device 510 with a restaurant, such as restaurant 530, for example.

The various configurations and/or techniques described herein are exemplary in nature. Disclosed implementations, embodiments, or examples are not to be considered in a limiting sense, because numerous variations are possible. The methods, processes, and/or functions described herein may represent one or more of any suitable number of processing strategies. The various methods, processes, and/or functions that have been described and/or depicted may be performed in the disclosed sequence, in other sequences, in parallel, or in some cases omitted. The subject matter of the present disclosure includes all novel and non-obvious combinations and sub-combinations of the various configurations and techniques, and other features, functions, acts, and/or properties disclosed herein, as well as any and all equivalents thereof.

1. A computerized method for displaying in-restaurant promotions on a mobile device, the method comprising:
detecting the existence of a dining event currently underway in a restaurant via a mobile device, the dining event indicating presence of the mobile device in the restaurant, and further indicating a stage of a dining experience;
displaying an electronic restaurant menu at a graphical display of the mobile device;
identifying a promotion based on the stage of the dining experience and the presence of the mobile device in the restaurant, the promotion being associated with a menu item on the electronic restaurant menu; and
displaying the promotion at the graphical display of the mobile device.

2. The method of claim 1, further comprising, varying the promotion displayed at the graphical display of the mobile device responsive to the stage of the dining experience changing over time.

3. The method of claim 1, further comprising:
tracking user order preferences based on in-restaurant orders made from the mobile device, in a plurality of different restaurants;
wherein the promotion is identified further based on the user order preferences.

4. The method of claim 3, wherein tracking user order preferences is accomplished at least in part by:
for each of the plurality of restaurants,
determining presence of the mobile device of a user at the respective restaurant;
downloading restaurant data including a menu having at least one menu option for the respective restaurant to the mobile device;
receiving user order input for at least one menu selection from the menu options of the menu, via the mobile device;
receive confirmation of the user order input, via the mobile device;
send a message from the mobile device to a remote server with the user order preferences based on the at least one menu selection in the order; and
at the server, augment the user profile based on the user order preferences.

5. The method of claim 4, wherein the user order preferences include order history or weighted category preferences for different categories of food and drink.

6. The method of claim 4, wherein menus for each restaurant include metadata assigning categories and values to each menu item, for use in generating the weighted category preferences for each menu selection.

7. The method of claim 1, further comprising, selecting the stage of the dining experience from a group consisting of: restaurant arrival, seating, menu service, drink service, appetizer and main course service, dessert service, payment, restaurant departure.

8. The method of claim 1, further comprising, selecting the stage of the dining experience from a group consisting of: first round of drinks, second round of drinks, third round of drinks.

9. The method of claim 1, wherein the promotion is a pull promotion inserted into the electronic restaurant menu.

10. The method of claim 9, further comprising, displaying the pull promotion as an inline advertisement in the electronic restaurant menu.

11. The method of claim 9, further comprising, displaying the pull promotion as a sponsored menu item visually set apart from other menu items in the electronic restaurant menu.

12. The method of claim 9, further comprising, displaying the pull promotion as image associated with a menu item in the electronic restaurant menu.

13. The method of claim 9, further comprising, displaying the pull promotion in a higher rank in the electronic restaurant menu as compared to other menu items and/or in an exaggerated size, color, typeface, or highlighting as compared to the other menu items.

14. The method of claim 1, wherein identifying the promotion is further based on other items in a pending order placed via the mobile device.

15. A method for computerized restaurant menu generation, the method comprising:
displaying an electronic restaurant menu at a graphical display associated with a computing device, the electronic restaurant menu including a plurality of menu items for food and/or drink;
receiving user input at the computing device, the user input indicating one or more selected menu items from a user, to thereby generate a pending order including the selected menu items;
prior to placing the pending order in an order queue for fulfillment, determining whether any related electronic promotions exist for other menu items not included in the pending order, based on matching criteria including existence of the selected menu items in the pending order; and
if a related promotion exists, then displaying a graphical indication of the related promotion at the graphical display, along with or including a selector for selecting the promotion.

16. The method of claim 15, further comprising:
receiving a user input selecting the promotion at the mobile device; and
in response to receiving the user input, selecting the promotion, changing the pending order to add a promotion menu item and/or delete an existing selected menu item.

17. The method of claim 15, wherein determining whether any related electronic promotions exist includes:
querying a local or remote promotions database server for promotions that match the matching criteria; and
receiving a response from the database server with a matching promotion;
wherein the electronic restaurant menu is preformatted to include space in which the matching promotion may be displayed adjacent the pending order.

18. The method of claim 15, further comprising:
determining a user identifier associated with the user;
querying a user profile database to retrieve a user profile associated with the user, the user profile containing preference data and order history data;
wherein the matching criteria further include the preference data and the order history data in the user profile, and such that related promotions are matched to the user profile data during determining whether any related electronic promotions exist for other menu items not included in the pending order.

19. The method of claim 18, wherein the electronic restaurant menu is a customized electronic restaurant menu having content and format that is adjusted based on the user profile.

20. The method of claim 18, further comprising:
wherein the user profile includes preference data and order history data that has been aggregated from a plurality of different restaurants.
